(19) United States
(12) Patent Application Publication
(10) Pub. No.: US 2007/0219855 A1
(43) Pub. Date: Sep. 20, 2007

(54) Method and System to Decentralize Patent Examination

(75) Inventors: Andrew S. Van Luchene, Santa Fe, NM (US); Raymond J. Mueller, Palm Beach Gardens, FL (US); Dean Alderucci, Westport, CT (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/734,923

(22) Filed: Apr. 13, 2007

Related U.S. Application Data
(63) Continuation-in-part of application No. 11/462,621, filed on Aug. 4, 2006.
(60) Provisional application No. 60/727,191, filed on Oct. 14, 2005.

(51) Int. Cl. H04M 3/51

(52) U.S. Cl. 705/11

(57) ABSTRACT

The present disclosure provides various novel means for outsourcing patent applications for examination. The disclosure describes various automated and non-automated means for selecting a qualified agency and examiner to perform the examination. The disclosure further discloses means for review of a patent at the request of holders of patents, licensees or other third parties who may be interested in acquiring a patent or application.

### PRIORITY CLAIM

The following application is a continuation in party of U.S. patent application Ser. No. 11/462,621, filed Aug. 4, 2006, which claims the benefit of U.S. Provisional Patent Application Ser. No. 60/727,191 filed Oct. 14, 2005. Each of which is hereby incorporated by reference.

### BACKGROUND

Protecting intellectual property through patent systems is a vital part of most countries' national economies and well as the global economy. However, many patent systems are facing a number of challenges due to the increased technical complexity of patent applications as well as with the challenge of hiring and training new patent examiners to cope with the increasing number of applications being filed.

In 2000, 311,807 patent applications were filed in the U.S. This number increased to 409,532 applications in 2005. The U.S. Patent and Trademark Office is anticipating at least an 8% increase per year in the number of applications filed through 2011. (U.S. PTO Strategic Plan 2007-2012). Globally, 145,300 applications were filed under the Patent Cooperation Treaty in 2006, representing a 6.4% growth over the previous year.

In an effort to deal with the increasing number of applications, the U.S. Patent and Trademark Office hired 1,193 new patent examiners in 2006 and plans to hire an additional 1,200 in 2007 (U.S. PTO Strategic Plan 2007-2012). The increased hiring has created issues in regards to training and housing.

Patent pendency in the U.S. now averages more than 31 months. In areas of emerging and rapidly changing technologies, delays may be longer, creating uncertainty as to the validity and commercial value of an invention thereby decreasing the usefulness of a patent as well as the spread of knowledge that the patent systems have been designed to promote.

The problems in the protection of intellectual property rights has been further compounded by virtual reality games. Hundreds of thousands of players access games known as massive multi-player online games (MMOGs) and massive multi-player online role playing games (MMORPGs). Players of these games customarily access a game repeatedly (for durations typically ranging from a few minutes to several days) over a given period of time, which may be days, weeks, months or even years. Many of these games purport to give intellectual property rights to the players in their virtual creations. However, these games lack a structured system for evaluating and granting such rights.

Given the increasing number of applications being filed and the increased demand for protection of intellectual property, it would be advantageous to provide alternate means for examining applications.

### BRIEF DESCRIPTION OF THE DRAWINGS

FIG. 1 is a block diagram depicting a system 100 of an embodiment of the present invention.

FIG. 2 is an embodiment of a method of assigning an application to an examiner according to one embodiment of the application.

FIG. 3 is a block diagram depicting a system 200 of an embodiment of the present invention.

FIG. 4 is an embodiment of a method of reviewing an application or patent according to an embodiment of the application.

FIG. 5 is a block diagram depicting a system 300 according to an embodiment of the present invention.

### DETAILED DESCRIPTION

A patent is a means for protecting the rights of an inventor. It is a property right granted to an inventor by a governing entity or by a regional office or other third party acting for a governing entity or group of government entities. This right allows the inventor to exclude anyone else from commercially exploiting the inventor's invention for a set time period. What is granted is not the right to make, use, offer for sale, sell or import, but the right to exclude others from making, using, offering for sale, selling or importing the invention.

By granting an exclusive right, patents provide incentives to inventors offering them recognition for their creativity and material reward for their marketable inventions. These incentives encourage innovation. Due to the steady increase in the number of applications being filed, the burden on various patent offices has increased. This increase has resulted in delays in reviewing applications and increased workloads for examiners. There have been many efforts to streamline the patent application process, shorten examination times and ensure the quality of issued patents. However, the sheer number of applications submitted can be overwhelming.

Various embodiments of the present invention address this issue by providing methods and systems for outsourcing patent examination. Decentralizing patent examination may decrease costs, increase competitiveness, decrease bureaucracy, and relieve the backlog of applications that is frustrating many patent systems. Such a system may be used to distribute workloads more evenly, evaluate efficiency and accuracy as well as increase the resources available for evaluating applications and issued patents

In various embodiments, the following terms may have or include the following meanings:

Abstract of the Invention—shall mean that part of a patent application that is the abstract as defined by the USPTO guidelines.

Agent—shall mean the agent responsible for filing a patent application.

Alternate Language—shall mean words that can be used as alternates for words in a patent application.

Artificial Intelligence—shall mean any computer program that uses neural nets and genetic algorithms.

Assignee Name—shall have the meaning defined by the USPTO guidelines.

Assignee City—shall have the meaning defined by the USPTO guidelines.

Assignee State—shall have the meaning defined by the USPTO guidelines.

Assignee Country—shall have the meaning defined by the USPTO guidelines.

Attorney—shall mean the attorney responsible for drafting and/or filing a patent application.

Attorney Name—shall have the meaning defined by the USPTO guidelines.

Attorney Address—shall have the meaning defined by the USPTO guidelines.

Attorney State—shall have the meaning defined by the USPTO guidelines.

Attorney Country—shall have the meaning defined by the USPTO guidelines.

Background of the Invention—shall meant that part of a patent application that is background as defined by the USPTO guidelines.

Claims—shall meant that part of a patent application that is claims as defined by the USPTO guidelines.

Date Stamp—Shall mean an electronic, unalterable stamp on an electronic file indicated the date that the file was created or received by a computer system.

Date of Invention—shall mean the date a patent application has with a first time stamp.

Degree of infringement—shall mean the statistically measured amount that a product or technical white paper infringes an issued patent application.

Description of the Invention—shall mean that part of a patent application that is description as defined by the USPTO guidelines.

Draftsperson—shall have the meaning defined by the USPTO guidelines.

Dollar Value—shall mean a dollar amount that is defined as the value of a patent license of a patent.

End User—shall mean any user of a system including an inventor, researcher, attorney, or agent who is interacts wiuth the system, e.g., by creating, enhancing, researching, filing, prosecuting, licensing, or invalidating a patent application. An end user may be required to be a member of a central system.

Electronic notification—shall mean an email or other means of digitally sending a message with a date and time stamp to an electronic address.

Errors and Omissions—shall have the meaning defined by the USPTO guidelines

Examiner—shall mean a patent examiner.

Issued Patent—shall have the meaning defined by the USPTO guidelines.

Filing Date—shall be the time stamp of the date that a patent application was submitted to the patent office.

Filed Patent—shall mean a patent application that is filed with the USPTO.

File Wrapper—Shall mean all files associated with a patent application including but not limited to: the patent application, a certified search, notes of distinguishing language, notes of rejection, notes of additional distinguishing language, record of interview, additional prior art references, and all electronic notifications associated with a patent application.

First Office Action—shall have the meaning described in the USPTO guidelines.

Genetic Algorithm—shall mean a computer algorithm that is capable of modifying and improving itself over time.

Infringement—shall mean that a product or technical white paper practices the invention protected by the claims of an issued patent.

Interview—shall mean an electronically recorded conversation between an end user and a patent examiner.

Invention Class—shall have the meaning described in the USPTO guidelines.

Invention Subclass—shall have the meaning described in the USPTO guidelines.

Invention Figures—shall have the meaning described in the USPTO guidelines.

Invention Claims—shall have the meaning described in the USPTO guidelines.

Inventor Name—shall have the meaning described in the USPTO guidelines.

Inventor City—shall have the meaning described in the USPTO guidelines.

Inventor State—shall have the meaning described in the USPTO guidelines.

Inventor Country—shall have the meaning described in the USPTO guidelines.

Issued Patent—shall have the meaning described in the USPTO guidelines.

Literature Prior Art—shall be prior art for a patent application other than patents.

Missing Parts—shall have the meaning described in the USPTO guidelines.

Non-Obviousness Score—shall mean a score given to a patent application by a central system that relates the obviousness of the invention disclosed by the patent application to prior art cited by the central system.

Notice of allowance—shall have the meaning defined by the USPTO guidelines.

Notes—shall mean any language added to a prior art record by an end user.

Note of distinguishing language—shall mean notes provided by end users in response to the prior art cited in a certified search. These notes distinguish a patent application submitted by the end user over the prior art references contained in the certified search provided by the central system.

Note of additional distinguishing language—shall mean notes provided by end users in response to a second office action conducted by a patent examiner.

Note of rejection—shall be the notes contained in a second office action provided by a patent examiner.

Novel—shall have the meaning described in the USPTO guidelines.

Novelty Score—shall mean a score given to a patent application by a central system that related the novelty of the invention disclosed in the patent application to prior art cited by the central system.

Obvious—shall have the meaning described in the USPTO guidelines.

Office Action—shall have the meaning described in the USPTO guidelines.

Online Chat Room—shall mean any electronic correspondence medium that allows for a real time, electronic conversation between a patent examiner and an end user.

Patent Application—Shall mean any document created to describe and invention by an end user.

Patent Application Data—Shall mean data contained in a patent application.

Patent Application Date—shall mean the time stamped date that a patent application was entered into a central system.

Patent Examiner—shall mean a person responsible for reviewing the patent application and deciding if the patent can be issued.

Patent examination queue—shall be the queue of patent applications that are assigned to a patent examiner that require office actions or reexaminations.

Patent invalidator—shall mean an end user who is attempting to invalidate an issued patent.

Patent License—shall mean a legal right to use an invention disclosed in an issued patent.

Patent Licensee—shall mean an end user who is licensing an issued patent.

Patent Office—Shall mean the United State Patent and Trademark Office (what about the rest of the world?).

Patent Prior Art—shall mean prior art that is filed and issued patents.

Patent Value score—shall mean a score assigned by an artificial intelligence system that demonstrates the strength of the claims of an issued patent in light of prior art.

PCT Information—shall have the meaning described in the USPTO guidelines.

Potential Licensee—shall mean an end user who may want to license an issued patent.

Prior Art—shall mean any document with a time stamp prior to the time stamp of a patent application.

Prior Art Data—Shall mean data that is prior art.

Priority Date—shall have the meaning described in the USPTO guidelines.

Product—shall mean a created thing that can be protected by or that can infringe the claims of an issued patent.

Published Prior Art—shall mean prior art that is available for review by the general public.

Reexamination—shall mean a second examination of a patent after it has been issued.

Relevance Score—shall mean a score assigned by an end user or by a central system to a particular piece of prior art as it relates to a particular patent application.

Research Report—shall mean a report assemble by a researcher or a central system that contains prior art related to a patent application.

Researcher—shall mean a person who manually researches prior art databases to find prior art related to a patent application.

Score—shall mean a numerical value assigned to something as it relates to something else.

Second Office Action—shall have the meaning described in the USPTO guidelines.

Second examination—shall mean reexamination.

Status Change—shall mean a change in status of a patent application as it moves through the patent process. Changes in status can include but are not limited submitting the application for examination, receiving a certified search for the application, placing the patent application in an examiner queue, receiving an office action for the patent application, receiving a notice of allowance for the patent application, receiving a notice of missing parts for the patent application; receiving a patent number for the patent application, and receiving an indication of interest from a potential licensee for the patent application.

Submitted Patent Application—shall mean a patent application that an end user submits to the central system for examination.

Subsequent Patent Application—shall mean an application that comes after a patent application.

Technical white paper—shall mean a text description of a product that describes the parts of the product and how they work together.

Time Stamp—shall mean an unalterable recording of the time a document was created by, entered into, or received by a system.

Title—shall have the meaning described in the USPTO guidelines.

Web-Based Application—shall mean an application that is accessible on the World Wide Web via a web browser such as Microsoft's Internet Explorer. The application will be stored on a central server and accessed via other computers.

Web-Based Form—shall mean an electronic form used to enter information by and end user into a web-based application.

Unpublished Prior Art—shall mean prior art that is not available to the general public, but that can be viewed by employees of the central system.

Useful—shall have the meaning described in the USPTO guidelines.

Usefulness Score—shall mean a score given to a patent application based on its usefulness as defined by the USPTO guidelines.

Decentralizing examination would allow for increased review of applications and a fluidity in the examination process that would be adaptable to increasing and/or decreasing demands on a patent system without the problems created by having a central administration directly recruit, hire and train new examiners. The biggest barrier to decentralizing the examination process is the confidentiality of patent applications. However, since most applications publish within eighteen months of filing, this is becoming less of an issue. In some embodiments, assignment to an outside examiner could be limited until after the application is published. In other embodiments, applications which will not publish may only be examined by centralized examiners. In a further embodiment, all information in an application may be confidential until the application issues. In some embodiments, in the event that an application is unpublished, all inventor or assignee data may be purged from the application before it is assigned to an outside examiner.

In some embodiments, decentralized examination may take place by directly assigning applications to outside examiners on a contract basis or other flexible means. In other embodiments, outside agencies may be staffed with examiners and contracts may be created between a centralized agency and the outside agency which would be responsible for all hiring and employment related matters.

In some embodiments, entities that wish to examine applications may register with a central office. Entities may submit information regarding the areas of art in which they have qualified examiners, the types of patents they are willing to examine or reexamine, rates, the number of applications they can handle or any other relevant information. In some embodiments, a database may be created of all of the examination entities and their histories. Such information may be used to create a profile of examining entities. This profile may be used to determine the examining entity with the examiners with the most relevant experience, the efficiency of an examining entity, the turnover rate, the appeal rate and the workload of any particular examining entity. Histories of examining entities may include information regarding applications the examining entity has previously examined, current employees, education of current employees, area of specialization, timeliness, number of applications reviewed, results of reviews, number of applications appealed, the results of appeals, current applications being considered, efficiency ratings or any combination thereof.

In other embodiments, databases may be created of all examiners and their place of employment, whether independent or through an agency. Profiles of specific examiners may include previous applications that the examiner has examined, the patent applications in the examiner's queue for examination, the examiner's efficiency rating, the prior art cited in the previous and/or pending applications, the examiner's education, the examiner's particular area of expertise, the length of time it takes the examiner to examine an application, the examiner's grade or level, the examiner's seniority, the examiner's previous experience, the examiner's training, the number of reissues in previously examined applications, the number of reviews, the results of reviewed applications, the number of appeals filed, the results of appealed applications, or any combination thereof. In some embodiments, an examiner's effectiveness may be evaluated and included in a profile. Effectiveness may be determined by any combination of variables such as the speed of the examiner, the accuracy of the examination, the number of times a ruling is appealed or overturned, the number of times an application is invalidated, ranking submitted by applicants, peers, and other interested parties, or any combination thereof. In some embodiments, all examiners may be required to be certified by a centralized agency. In other embodiments, training may be undertaken by the examining entities. The levels of certification and/or the types of certification may be included in the profile of each examiner.

In some embodiments, the elements of a profile may be assigned a number and a total score for an examining entity and/or examiner may be generated. In some embodiments, the elements may be weighted. In further embodiments, the weighting of the elements may change depending on the use of the score. For example, the weighting may change depending on the information in the application. Some areas of technology may require more outside knowledge than others. In those instances, the examiner's previous education may carry more weight than other elements of a profile. In technology areas that require less specific knowledge, other elements of the profile may carry more weight. In some embodiments, the score generated may be a relevance score relating to the examiner's area of expertise in relation to a particular application.

When a new application is submitted to a patent office for examination, the field of invention, class, subclass, abstract, claims, or any combination thereof is reviewed for subject matter and an area of expertise for review is determined. Such a review may be run using a simple table based method, a rules based system, or artificial intelligence techniques, for example neural net, Bayesian algorithm, genetic algorithms, pattern recognition, expert systems, case based reasoning, fuzzy systems, hybrid intelligent systems, evolutionary computation, concept processing or any combination thereof.

In some embodiments, the submitted application is compared to the score generated by the examining entity profile and/or the patent examiner profile. Examining entities and/or examiners whose profiles are comprised of those patent applications and prior art references that are most relevant to the patent application being submitted are given the highest relevance scores.

In other embodiments, the current queues of examining entities and examiners are reviewed for workload and a queue score is determined. In some embodiments, workload is evaluated prior to determining relevance of experience. For example, examiners may not be eligible to receive an application for examination if the score they receive for their current workload is too high. Workload may be evaluated and a queue score may be calculated based on the number of applications the examiner is currently reviewing, the average length of time the examiner takes to process an application, the expected length of time to process a new application, or any combination thereof. In some embodiments, determinations may be made by the examiner, his peers or the public. In other embodiments, determinations may be made using artificial intelligence and genetic algorithms. In some embodiments, scores from different sources may be aggregated. Such an aggregation may or may not be weighted. In additional embodiments, the workload scores of examiners should be effectively equal. In order to address an imbalance or inequity, applications that are waiting to be examined may be reassigned to other examiners.

The examining entity or examiner with the most closely related relevance score(s) and the workload score indicating the most availability may then be assigned the application. In some embodiments, such a decision may be made by the central office. In other embodiments, applications may be assigned to a particular examining entity and the examining entity may control distribution to a particular examiner. In some embodiments, the comparison of the relevance score and workload score may be weighted. In other embodiments, for example in particularly specialized fields, the workload score may be disregarded.

In some embodiments, the system may be designed to receive feedback. Such feedback may be used to increase the accuracy of the assignment and the weighting of the scoring. For example, the assigned examiner may submit their time estimate for reviewing the application. This time estimate may be shorter or longer than that calculated by the system. In another embodiment, the examiner could determine that he or she does not have the necessary expertise in the field of the application and may request reassignment of the application. An examiner or examining entity could also indicate the appropriateness of the assignment. Such feedback could be incorporated into the algorithm to add to the efficiency of the system. Feedback may be used to continuously update the system, update it periodically, or may be used as part of a multivariate or regression analysis to alter the way information is processed.

Once an application is assigned to an examiner or examining entity, the end user may be informed. In some embodiments, the end user may be informed as to the examining entity or examiner charged with examining the application. In other embodiments, the identity of the examining entity and/or the examiner may be anonymous. The end user may additionally be informed of the number of applications ahead of their application. In some embodiments, applications can be moved ahead in the queue. Acceleration of examination may take place through the payment of additional fees, through the provision of services for the patent office, for example, through a peer review program, or some combination thereof.

In many research areas, it is not uncommon for researchers to continue to improve their invention. Each improvement or portion thereof may be filed as a separate application or a continuation in part of a currently pending application. In some embodiments, an end user may file a series of continuation-in-part applications prior to the examination of the first application. The filing of the first application may secure the application's place in an examiner's queue. In some embodiments, each subsequent related application may be stored with the first application. When the examiner reaches the parent application in the examination queue, the end user can be notified and may select any of the continuation-in-part applications for examination. The remaining applications may be abandoned, or placed back in the examiner's queue.

During examination, an end user may desire to communicate with an examiner. Such communication may take place by any means possible. In some embodiments, such communication may be in person. In other embodiments, such communication may be in writing, by phone, facsimile, electronic mail, in a chat room, or in any other medium for communication. In some embodiments, the examiner may be anonymous. Anonymity may be preserved through the use of aliases, online chat rooms, anonymous e-mail encryption, or any combination thereof. In some embodiments, the request for real time communication may be submitted to a central system. An end user may supply a list of times available for the communication, or may wait to receive a list of times available from the examiner. A transcript of the interview and/or a summary of the interview may become part of the application file.

During examination, an examiner may issue one or more rejections of the claims in the application in view of the prior art. In some embodiments, one examiner may be responsible for the examination of the application. In other embodiments, once an initial series of rejections has been issued by an examiner, the application may be sent to a second examiner for review or additional commentary. The number of rejections that may be issued may vary depending on the application, the fees paid, the number of claims, a combination thereof, or may be constant.

In some embodiments, an issued patent may be reexamined. Such a reexamination may take place at the request of the end user, a potential licensee, a patent invalidator, or other third party. In some embodiments, additional prior art may be submitted with the request for review. Such a request may provide assurance for the owner and/or licensee as to the validity and/or strength of a particular patent. In some embodiments, the review is undertaken by the initial examiner. In other embodiments, the review is undertaken by a different examiner. In further embodiments, the application may be assigned to an examiner at a different examining entity then the original examiner. In another embodiment, the application may be assigned to a different examiner at the same examining entity. In further embodiments, such requests may be handled by a central patent examination office. Requests for reexamination may be accompanied by a fee. Such a fee may be constant for all requesters, or may vary depending on the requester. In some embodiments, there may be graduated fees depending on the number of times an application has been reviewed. Such fees may increase or decrease depending on the number of times an application has been reviewed. In some embodiments, there may be a cap on the fees. In other embodiments, an application may only be reviewed a certain number of times. In further embodiments, each licensee or other third party may request a review.

In the event that the subsequent examination determines that an application is invalid, the patent application may be assigned to an additional examiner for review. If the additional examiner determines that the application is valid, the subsequent examiner is overruled. If the additional examiner determines that the patent is invalid then the initial examiner is overruled. In some embodiments, the subsequent and/or initial examiner may be able to defend their decision regarding patentability. In another embodiment, review of patentability may be made by the courts. In the event a patent is invalidated, such information may be entered into the central system.

In the event that a patent is found to be invalid, a note may be made in the examiner's file. In some embodiments, the examiner may receive a demerit. If a certain number of invalidations occur, an examiner may be required to receive retraining. In some embodiments, an examiner may be prohibited from examining applications in a particular field. In a further embodiment, an examiner may be prohibited from examining applications. In additional embodiments, if an examining entity has a certain number of patents invalidated, they may be barred from receiving more applications.

If a patent is found to be valid, a note may be made in the examiner's file. Such examiners and/or the examining agency may receive merit bonuses or other recognition for their examination. Such information may additionally be added to the profile of the examiner and/or examining agency.

In a further embodiment, patent applications and/or office actions may be reviewed by a peer or other third party. Requests for such review may be made by holders of prior art cited against an application, the applicant or end user, the system or a third party. Such requests for review may be sent to other examiners or non-examiners. For example, a patent attorney that is unaffiliated with a particular case could review an examiner's work and provide feedback in the form of a numeric score and/or comments. Applications could be assigned to patent attorneys who volunteer for such service, or all patent attorneys may be required to review a set number of applications in a specific time period. In some embodiments, the patent attorneys who provide such services may be compensated. Such compensation may be payment of a fee, reduction of patent office fees for the applications that patent attorney files, acceleration of examination for that patent attorney's applications, or any combination thereof.

In some embodiments, such a request for a review may be made by the system as a means of verifying the examination process and ensuring fidelity of applications. Determinations as to which applications to submit for outside review may be based on the disparity in the relevancy scores between the examiner and the application, the examiner's efficiency rating, the complexity, length and technology of the application, the number of office actions received or continuations filed, notes attached to the application, at random, or any combination thereof. In some embodiments, information received from the review may be used for training automated systems used in assigning, searching and distributing applications.

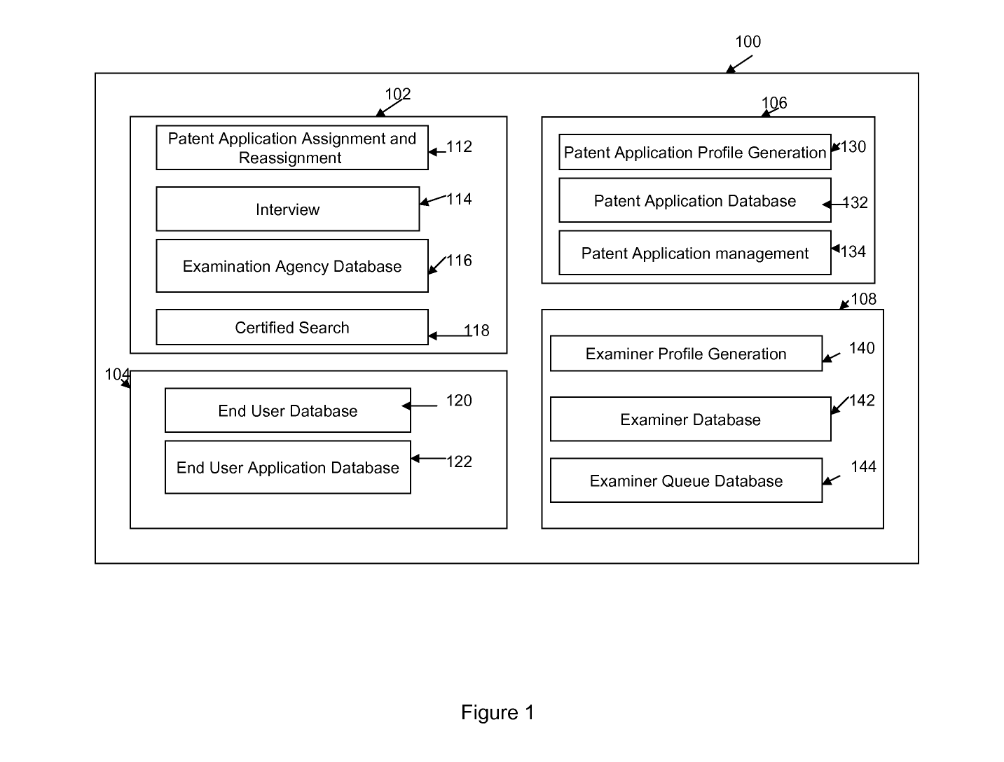

FIG. 1 provides an exemplary system 100 that may be used to provide the embodiment described above. As shown, system 100 may include central server 102, End user server 104, Application server 106, Examiner server 108, and Review server 110.

Central server 102 may include programs such as patent application assignment and reassignment 112, interview program 114, certified search program 118 and various databases such as examination agency database 116.

End user server 104 may include an end user database 120 and end user application database 122.

Application server 106 may include programs such as patent application profile generation program 130, patent application management program 134 and patent application database 132.

Examiner server 108 may include programs such as examiner profile generation program 140, as well as various databases such as examiner database 142, and examiner queue database 144.

Applications for examination, whether initial examination or subsequent review, may be submitted by any means possible. In some embodiments, applications may be submitted electronically. In other embodiments, applications may be submitted on paper. In a further embodiment, applications may be submitted by facsimile.

Information regarding applications and/or the application themselves may be stored, for example, in patent application database 132. Such a database may include information such as application ID, application data, certified search ID, distinguishing language data, application class, application subclass, end user ID, file date, application score, application length, priority, related applications, and application claims.

Once submitted, a profile of the application may be generated, for example using patent application profile generation program 130. A profile score for a patent application may be calculated, for example, using some or all of the following steps:
1. Receive patent application.
2. Generate score for patent application based on patent application data.
3. Store patent application score.

The score for a patent application may then be compared to the score for an examination agency. Information on an examination agency may be stored, for example in examination agency database 116. Examination agency database 116 may include information such as agency ID, agency subject matter, the efficiency of an examining entity, the turnover rate, applications the examining entity has previously examined, current employees, education of current employees, area of specialization of examining entities, number of applications reviewed, results of reviews, number of applications appealed, the results of appeals, current applications being considered, efficiency ratings or any combination thereof.

In some embodiments, an application may be assigned to a specific examiner in an agency by comparing the profile or relevance score of an examiner with the profile of an application. Information regarding examiners may be stored, by any means applicable, for example in patent examiner database 142. Patent examiner database 142 may include information such as, but not limited to, patent examiner history which may include information such as, examiner ID, examiner profile, examiner work load, previous examinations, examiner education, examiner experience, examiner training and examiner score.

A profile for an examiner may be calculated, for example, using patent examiner profile generation program 140. Patent examiner profile generation program 140 may be configured, for example, to use some or all of the following steps:
1. Retrieve patent examiner history.
2. Retrieve patent applications previously examined by examiner.
3. Generate a score for patent examiner based on applications previously examined by examiner and patent examiner history.
4. Store patent examiner score.

Once the profile for an examiner has been compiled, the scores of a patent application and the examiner may be compared to locate the examiner with the most relevant experience. An application may be assigned to an examiner by a central office or by the examining agency. In some embodiments, applications may be assigned using patent application assignment and reassignment program 112. Such a program may, for example, be configured to use some or all of the following steps:
1. Retrieve patent application score.
2. Generate list of examiners with scores closest to patent application.
3. Assign patent application to examiner based on score.
   The location of each application and its status may be tracked using, for example, patent application management program 134.

In some embodiments, the current workload of an examiner may be taken into consideration. Such information may be stored, for example in patent examiner queue database 144. Patent examiner queue database 144 may include information such as examiner ID, application ID 1-n, target completion date 1-n, priority fee 1-n, queue score. The current workload of an examiner may be taken into consideration using, for example, some or all of the following steps:
1. Retrieve patent application score.
2. Generate list of patent examiners with scores closest to patent application
3. Retrieve patent examiner queue scores.
4. Assign patent application to patent examiner based on score and queue score.

In other embodiments, workload may be taken into consideration prior to the selection of examiners with the closes relevance scores. For example, using some or all of the following steps:
1. Calculate examiner queue score.
2. Retrieve patent application score.
3. Retrieve patent examiner relevance scores.
4. Disregard examiners with highest queue score.
5. Assign application to examiner with closest remaining relevance score.

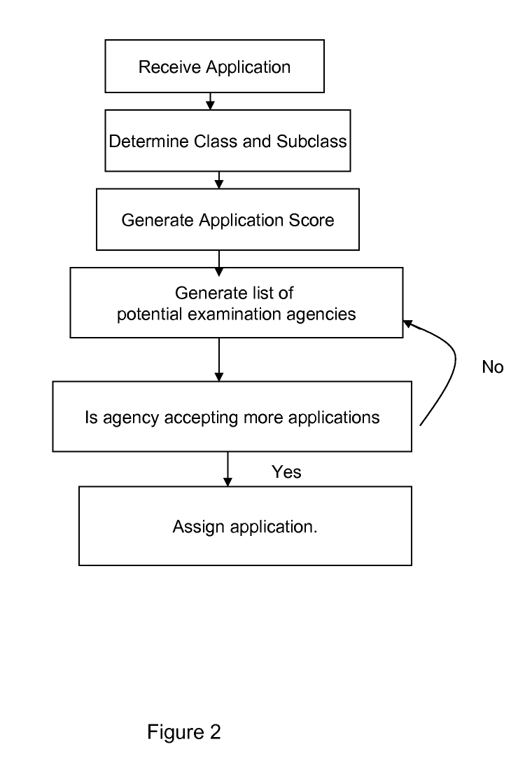

Assignment of an application may be done by a central office or by an examining agency or entity. In some embodiments, the current workload of an examining entity may be taken into consideration by the central office prior to assigning an application or group of applications to the examining entity. In one embodiment, applications may be assigned to an examining agency using some or all of the steps in FIG. 2. As seen in FIG. 2, an application is received by a central office. Its class and subclass is determined and an application score is generated. An application score may be generated manually, or using a variety of automated means including, but not limited to, simple table based method, a rules based system, or artificial intelligence techniques, for example neural net, Bayesian algorithm, genetic algorithms, pattern recognition, expert systems, case based reasoning, fuzzy systems, hybrid intelligent systems, evolutionary computation, concept processing or any combination thereof.

Once an application is assigned, an end user may be notified. Information regarding an end user may be stored, for example in end user database 120. Such a database may include information such as end user ID, assignee ID, end user profile, end user score and end user billing information. Information regarding the applications an end user has filed may be stored, for example in end user application database 122. End user application database 122 may include information such as end user ID and application ID. In some embodiments, an end user may be informed regarding the number of applications in the queue ahead of the end user's application, for example using information from examiner queue database 144. In other embodiments, the end user may be informed of the examiner and/or examining entity examining the application. In further embodiments, such information may be kept confidential.

During the examination process, the end user may seek to discuss the application with the examiner. Such a discussion may take place using, for example interview program 114. Interview program 114 may use some or all of the following steps to schedule the interview:
1. Receive request for an interview from an end user for a patent application.
2. Determine available times for examiner.
3. Output available times to end user.
4. Receive acceptance of a time.
5. Initiate interview at time specified.
   In the event that the identity of the examiner is to be kept secret, interview program 114 may facilitate anonymous discussions between the end user and the examiner. For example, such discussions may be facilitated using some or all of the following steps:
1. Receive end user log in.
2. Receive examiner log in.
3. Conduct interview.
4. Store interview results.
   In some embodiments summaries of the interview may be kept with the application. In other embodiments, transcripts of the interview may be kept with the application. In further embodiments, both a summary and a transcript of the interview may be kept with the application.

Searches of prior art may be run before or after an application is assigned. In one embodiment, a search can be conducted using a program such as certified search program 118. Such searches may be conducted using some or all of the following steps:
1. Receive Patent Application Data.
2. Retrieve Prior Art.
3. Compare Patent Application Data to Prior Art.
4. Identify Relevant Prior Art Documents.
5. Store Relevant Prior Art Documents with Patent Application and Time Stamp.
   In some embodiments, the results of searches may be stored with an application in patent application database 132.

The results of the search and or any comments by an examiner are sent to the end user. Information regarding the end user may be stored, for example, in the end user database such as end user database 122. An end user may respond to the prior art produced by the search as well as any comments by the examiner. Subsequent rejections may follow similar patterns with additional searches or comments from the examiner until the application is determined to be allowable and issues.

In some embodiments, it may be desirous to verify the validity and/or strength of a patent. A review system may be used to ensure the high quality of granted patents. In some embodiments, a review system may be used to reassure potential investors, licensees, the owner of the patent, or other third parties. For example, individuals or companies may wish to know the strength of a patent as part of the due diligence process. Such due diligence could be performed in preparation for an initial public offering, or on behalf of a licensee or acquirer of a patent portfolio. Such third parties may wish to have an application reexamined by a subsequent examiner to verify the decisions made by the initial examiner.

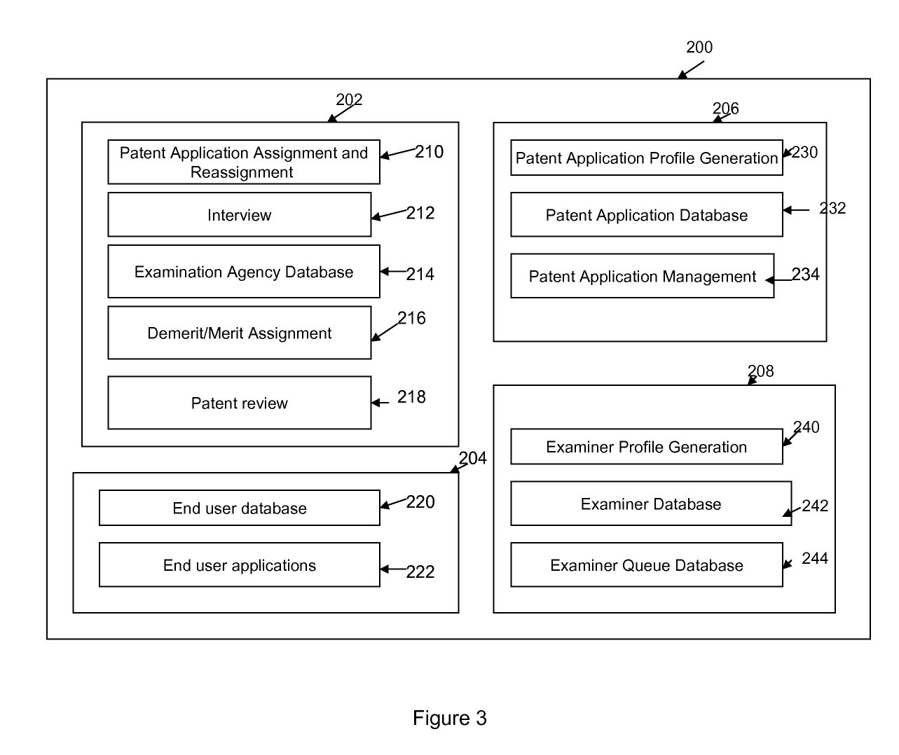

FIG. 3 provides an exemplary system 200 that may be used to provide the embodiment described above. As shown, system 200 may include Central server 202, End user server 204, Application server 206, and Examiner server 208.

Central server 202 may include programs such as patent application assignment and reassignment 212, interview program 214, demerit/merit assignment program 216, patent review program 218 and various databases such as examination agency database 116.

End user server 204 may include an end user database 220 and end user application database 222.

Application server 206 may include programs such as patent application profile generation program 230, patent application management program 234 and patent application database 232.

Examiner server 208 may include programs such as examiner profile generation program 240, as well as various databases such as examiner database 242, and examiner queue database 244.

A review system may be initiated to ensure the high quality of granted patents. In some embodiments, a review system may be initiated to review applications just prior to issuance or after issuance. Such a review may be particularly useful in areas of rapidly evolving technology, providing prior art that an examiner may not have located independently. Review may also be requested by patent invalidators, potential licensees, or as part of other due diligence processes. In some embodiments, review may be requested by the owner of the patent who may have identified a new piece of prior art they wish to have considered.

Information regarding applications and/or the application themselves may be stored, for example, in patent application database 232. Such a database may include information such as application ID, application data, certified search ID, distinguishing language data, application class, application subclass, end user ID, file date, application score, application length, priority, related applications, prior art, application claims, and date of issuance.

In some embodiments, requests for review may be submitted by the system. Such requests may be based on a combination of variables such as the difference in the relevancy score between the examiner and the application, the examiner's efficiency rating, the examiner's experience level, the complexity of the application, the newness of the technology, the length of the application, the number of amendments made to the claims, the prior art, the extent of notes by the examiner, randomly, or any combination thereof.

In other embodiments, holders of a patent may identify new prior art that they wish to have considered. In further embodiments, requests may be submitted by third parties such as potential purchasers or licensees.

Requests for review may require the payment of additional fees. Such fees may be fixed or variable. In some embodiments, the fees may increase or decrease depending on the number of times the patent has been reviewed and/or the type of requestor. For example, requests from the end user or applicant may be more expensive then requests from a potential licensee or vice versa.

Once a request for review is received, the history of the patent including prior examiners is retrieved. Such a history may include the file wrapper of the patent as well as any previous reviews or unconsidered prior art that may have been submitted or discovered during the prosecution of the application. In some embodiments, the request for review may be sent to the initial examiner. In other embodiments, the request for review may be sent to a subsequent examiner. For example, in the event the review is a request from the patent owner regarding a newly identified piece of prior art, the request may be sent to the initial examiner. In the event that the request is from a third party regarding the validity of the application, the request may be sent to a subsequent examiner. Decisions regarding who may examine the patent and/or application or management of the review(s) of a patent and/or application may be controlled, for example, using patent application management program 234.

In some embodiments, the profile of a patent may be recalculated, for example using patent application profile generation program 230. Such recalculations may take into account refinements in the profile process, permitting advancement and retraining of the methods used to create the profile including, but not limited to, automated means including, but not limited to, simple table based method, a rules based system, or artificial intelligence techniques, for example neural net, Bayesian algorithm, genetic algorithms, pattern recognition, expert systems, case based reasoning, fuzzy systems, hybrid intelligent systems, evolutionary computation, concept processing or any combination thereof. A profile score for a patent may be calculated, for example, using some or all of the following steps:
1. Receive patent for review.
2. Generate score for patent based on patent data.
3. Store patent score.

In some embodiments, the request for review may be sent to the same examination agency. In other embodiments, requests for review must be sent to a different examination agency. In some embodiments, there may be agencies that specialize or which only perform reviews of issued patents.

In order to determine the appropriate examination agency, the score for a patent may be compared to the score for an examination agency. Information on an examination agency may be stored, for example in examination agency database 214. Examination agency database 214 may include information such as agency ID, agency subject matter, the efficiency of an examining entity, the turnover rate, applications the examining entity has previously examined, current employees, education of current employees, area of specialization of examining entities, number of applications appealed, the results of appeals, current applications being considered, efficiency ratings or any combination thereof.

In some embodiments, a patent may be assigned to a specific examiner in an agency. For example, in one embodiment, only senior examiners may perform such a review. Information regarding examiners may be stored by any means applicable, for example in patent examiner database 242. Patent examiner database 242 may include information such as, but not limited to, patent examiner score, and patent examiner history which may include information such as, examiner ID, examiner profile, examiner work load, previous examinations, examiner education, examiner experience, and examiner training.

A profile for an examiner may be calculated, for example, using patent examiner profile generation program 240. Patent examiner profile generation program 240 may be configured, for example, to use some or all of the following steps:
1. Retrieve patent examiner history.
2. Retrieve patent applications previously examined by examiner.
3. Generate a score for patent examiner based on applications previously examined by examiner and patent examiner history.
4. Store patent examiner score.

Once the profile for an examiner has been compiled, the scores of the patent and the examiners may be compared to locate the examiner with the most relevant experience. A patent may be assigned to an examiner by a central office or by the examining agency. In some embodiments, applications may be assigned using patent application assignment and reassignment program 210. Such a program may, for example, be configured to use some or all of the following steps:
1. Retrieve application score of patent.
2. Generate list of examiners with scores closest to patent.
3. Retrieve requirements of review.
4. Assign patent to examiner based on score and requirements of review.

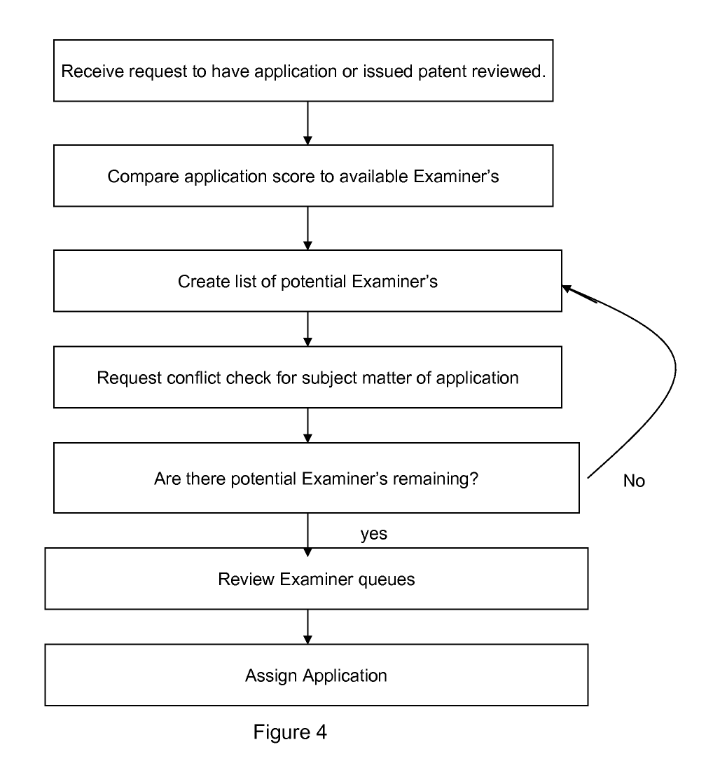

In some embodiments, assignment may take place using some or all of the steps in FIG. 4. As seen in FIG. 4, a request to an application or issued patent reviewed is received by the central office. The application score of a patent is compared to the scores of available examiners. In some embodiments, there may be a conflict that prevents an examiner from reviewing a particular patent. If the examiner(s) does not have a conflict, the workload of the examiner may be taken into consideration. In some embodiments, if an examiner has a large backlog of applications to examine and/or review, they may be removed from consideration for this review. The patent or application may then be assigned to the examiner with the lowest queue score.

Once a patent is assigned for review, the requestor may be notified. Information on the requester may be stored, for example in end user database 220. Such a database may include information such as end user ID, inventor ID, assignee ID, end user profile, end user score and end user billing information. Information regarding the applications an end user has filed or requested to be reviewed may be stored, for example in end user application database 222. End user application database 222 may include information such as end user ID and application ID. In some embodiments, an end user may be informed regarding the number of patents or applications in the queue ahead of the end user, for example using information from examiner queue database 244 which may include information such as the number of applications waiting to be examined and the average length of time for examination. In other embodiments, the end user may be informed of the examiner and/or examining entity examining the application. In further embodiments, such information may be kept confidential.

Review of a patent may take place using, for example patent review program 218. Such a program may use some or all of the following steps to perform a review.
1. Receive request to reexamine patent.
2. Determine fee for reexamination.
3. Apply fee to end user account.
4. Determine examiner to conduct reexamination.
5. Place patent application in queue of examiner.
6. Receive reexamination results.
7. Store reexamination results with time stamp.
8. If reexamination results are different than first examination results, determine tie breaker examiner and store patent application in tie breaker examiner queue.

During the review process, the end user may seek to discuss the patent with the Examiner, for example to specifically indicate or debate areas of concern. Such a discussion may take place using, for example interview program 212. Interview program 212 may use some or all of the following steps to schedule the interview:
1. Receive request for an interview from an end user for a patent.
2. Determine available times for examiner.
3. Output available times to end user.
4. Receive acceptance of a time.
5. Initiate interview at time specified.
   In the event that the identity of the examiner is to be kept secret, interview program 212 may facilitate anonymous discussions between the end user and the examiner. For example, such discussions may be facilitated using some or all of the following steps:
1. Receive end user log in.
2. Receive examiner log in.
3. Conduct interview.
4. Store interview results.

In some embodiments summaries of the interview may be kept with the application and/or patent. In other embodiments, transcripts of the interview may be kept with the application.

In the event the examiner determines the patent is invalid, a review by an additional examiner may be initiated. The additional examiner may be from the same or a different examining entity then the initial and additional examiners, and may be selected using methods similar to those described above for selecting other examiners. In some embodiments, the tiebreaker examiner must have additional training or experience. For example, in some embodiments, the tiebreaker examiner must be a primary examiner. A review by the additional examiner selected to break the tie may be preformed, for example, using patent review program 218 which may be configured to use some or all of the following steps.
1. Output reexamined patent to tiebreaker examiner.
2. Receive tiebreaker examination results.
3. Store results with Patent Application
4. Output notification to end user of tiebreaker examination results.

If it is determined that a patent is invalid, demerits may be given to the initial examiner. If the demerits exceed a certain number, the examiner may be required to receive retraining or may be prevented from examining applications in a particular field. The awarding of demerits may be included in the examiner's history and become part of the examiner's profile. In some embodiments, demerits may be awarded using demerit/merit assignment program 216. Demerit/merit assignment program 216 may use some or all of the following steps:
1. If reexamination and/or tiebreaker examination generate different results from first examination, retrieve examiner record of the first examination.
2. Determine demerit score.
3. Apply demerit score to examiner record.

If the patent is upheld, demerits may be awarded to the subsequent examiner and a merit award may be given to the initial examiner. The awarding of merit may be included in the examiner's history and become part of the examiner's profile. In some embodiments, merit may be awarded using demerit/merit assignment program 216. Demerit/merit assignment program 216 may use some or all of the following steps:
1. If reexamination validates first examination, retrieve examiner record of the first examination.
2. Determine merit score
3. Apply merit score to examiner record

In some embodiments, there may be an appeal from the decision of the additional examiner, for example through the court system.

In some embodiments, examination of an application may benefit from peer review. Such review may be by another examiner, or by a third party. In other embodiments, it may be useful to have reviews or comments on prior art. Such comments may be submitted by examiners, end users submitting the references with an application, or third parties. Comments may concern the relation of the references to a particular application, summaries of the references, general observations of the references, or any combination thereof. In additional embodiments, reviews of applications and/or office actions may be undertaken by patent attorneys or agents.

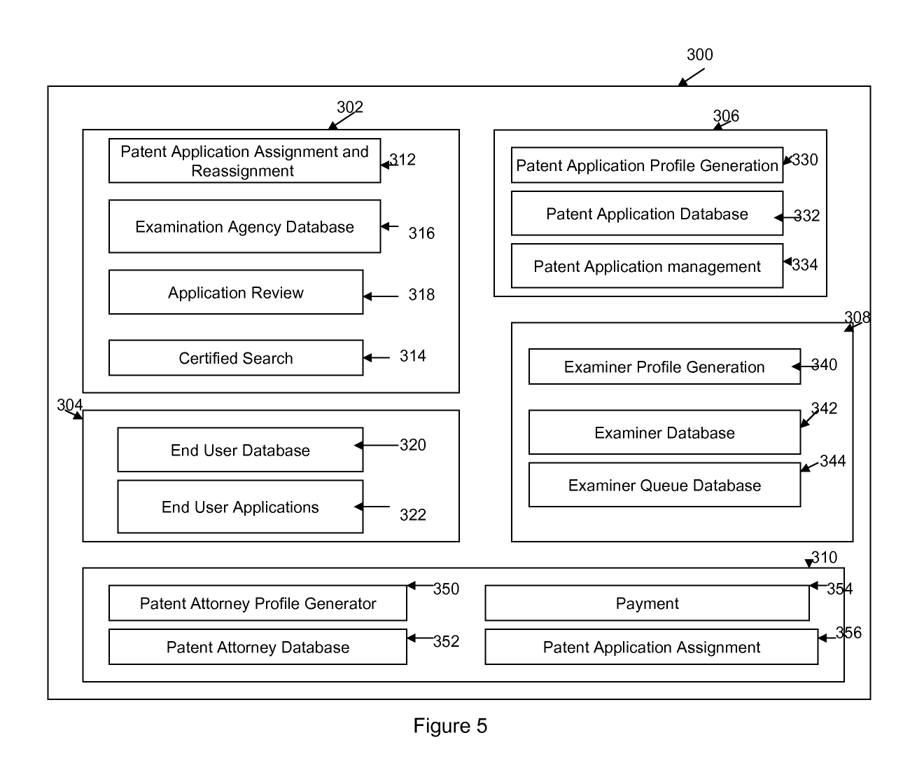

FIG. 5 provides an exemplary system 300 that may be used to provide the embodiment described above. As shown, system 300 may include central server 302, End user server 304, Application server 306, examiner server 308, and review server 3 10.

Central server 302 may include programs such as patent application assignment and reassignment 312, application review program 318, certified search program 314 and various databases such as examination agency database 316.

End user server 304 may include an end user database 320 and end user application database 322.

Application server 306 may include programs such as patent application profile generation program 330, patent application management program 334 and patent application database 332.

Examiner server 308 may include programs such as examiner profile generation program 340, as well as various databases such as examiner database 342, and examiner queue database 344.

Review server 310 may include various programs such as patent attorney profile generator program 350, payment program 354, patent application assignment program 356 and databases such as patent attorney database 352.

In some embodiments, examination of an application may benefit from collaboration. Such a collaborative system may add to the strength of issued patents by providing additional insight and critique. Examined applications may be reviewed by a peer or a third party at any point during the examination process. In some embodiments, an application may be reviewed, initial comments made and the application reassigned to a second examiner for additional input. In other embodiments, an application may be reviewed just prior to issuance of a notice of allowance. In a further embodiment, issued patents may be reviewed and subject to recall during a specific time period, for example during the first six months or the first five years after issuance.

When applications are received, they are processed and a profile is generated, for example using patent application profile generation program 330. A profile score for a patent application may be calculated, for example, using some or all of the following steps:
1. Receive patent application.
2. Generate score for patent application based on patent application data.
3. Store patent application score.

Patent application data may be stored, for example, in patent application database 332. Such a database may include information such as application ID, application data, certified search ID, distinguishing language data, application class, application subclass, end user ID, file date, application score, application length, priority, related applications, and application claims.

The score for a patent application may then be compared to the score for an examination agency. Information on an examination agency may be stored, for example in examination agency database 316. Examination agency database 316 may include information such as agency ID, agency subject matter, the efficiency of an examining entity, the turnover rate, applications the examining entity has previously examined, current employees, education of current employees, area of specialization of examining entities, number of applications appealed, the results of appeals, current applications being considered, efficiency ratings or any combination thereof.

In some embodiments, an application may be assigned to a specific examiner in an agency by comparing the profile or relevance score of an examiner with the profile of an application. Information regarding examiners may be stored, by any means applicable, for example in patent examiner database 342. Patent examiner database 342 may include information such as, but not limited to, examiner score and patent examiner history which may include information such as, examiner ID, examiner profile, examiner work load, previous examinations, examiner education, examiner experience, and examiner training. A profile for an examiner may be calculated, for example, using patent examiner profile generation program 340.

Once the profile for an examiner has been compiled, the scores of a patent application and the examiner may be compared to locate the examiner with the most relevant experience. An application may be assigned to an examiner by a central office or by the examining agency. In some embodiments, applications may be assigned using patent application assignment and reassignment program 312.

Once an application is assigned, an end user may be notified. Information regarding an end user may be stored, for example, in end user database 320. Such a database may include information such as end user ID, assignee ID, end user profile, end user score and end user billing information. Information regarding the applications an end user has filed may be stored, for example in end user application database 322. End user application database 322 may include information such as end user ID and application ID. In some embodiments, an end user may be informed regarding the number of applications in the queue ahead of the end user, for example using information from examiner queue database 344 which may include information such as examiner ID, number of applications waiting to be processed and average length of time for examination. In other embodiments, the end user may be informed of the examiner and/or examining entity examining the application. In further embodiments, such information may be kept confidential.

Searches of prior art may be run before or after an application is assigned. In one embodiment, search as conducted using a program such as certified search program 314. Such searches may be conducted using some or all of the following steps:
1. Receive Patent Application Data.
2. Retrieve Prior Art.
3. Compare Patent Application Data to Prior Art.
4. Identify Relevant Prior Art Documents.
5. Store Relevant Prior Art Documents with Patent Application and Time Stamp.
   In some embodiments, the results of searches may be stored with an application in patent application database 332.

The results of the search and or any comments by an examiner are sent to the end user. Information regarding the end user may be stored, for example, in the end user database such as end user database 322. An end user may respond to the prior art produced by the search as well as any comments by the Examiner. Subsequent rejections may follow similar patterns with additional searches or comments from the examiner until the application is determined to be allowable and issues.

In some embodiments, an application or a patent may be flagged for additional review using for example application review program 318. Additional review may be performed by another examiner or an outside party such as a patent attorney. Some patent attorneys may focus their practice entirely on the review of filed applications or may do so in conjunction to their own practice. A profile of each patent attorney willing to review applications may be compiled, for example, in patent attorney database 352. Patent attorney database 352 may include information such as, but not limited to, patent attorney ID, patent attorney profile, applications profiled, experience, education, years in practice, patent attorney score, previous applications reviewed, timeliness of review, conflicts, current clients, firm affiliation, or any additional information considered relevant to assigning an application to a particular patent attorney.

A profile for a patent attorney may be calculated, for example, using patent attorney profile generation program 350. Patent attorney profile generation program 350 may be configured, for example, to use some or all of the following steps:
1. Retrieve patent attorney record.
2. Retrieve applications previously filed by patent attorney.
3. Retrieve patent applications previously examined by patent attorney.
4. Generate a score for patent attorney based on applications previously examined and previously filed by patent attorney.
5. Store patent attorney score.

Once a patent attorney profile score is generated, it may be compared to the score of a particular application. Patent attorneys with the most relevant score may then be assigned an application for review using, for example, patent application assignment program 356. The placement of each patent and its status may be tracked using, for example patent application management program 334. In some embodiments, the reviewer may be sent a summary of the application or patent, or the application or patent itself if it has published in order to run a conflict check. In the event that the reviewer has a conflict, they must refuse the assignment.

In some embodiments, patent attorneys may receive remuneration for applications they review. Remuneration may include payment of a fee, reduction of patent office fees, acceleration of examination of pending applications, or any combination thereof. In other embodiments, review of a certain number of applications in a specific time period may be mandatory. In further embodiments, review may be voluntary. Information regarding the payments received or the type or amount of payment may be calculated, for example, using payment program 354.

The comments from the review may be viewed by the examiner, the examiner's supervisor, a central authority, or may be made public. In some embodiments, the examiner may use the comments to provide further rejections and/or refine an office action. In other embodiments, the comments from a reviewer may call into question the validity of a patent, requiring reexamination.

It will be appreciated that while, for the sake of discussion, various databases have been described separately, the data in these and any other suitable databases could be merged into a single large databases and/or maintained separately in additional databases, or in other structures besides a database. Moreover, any such databases could be independent or linked, and the data in these databases could be stored centrally on a server or separately on game devices.

The present disclosure provides numerous systems and methods related to examination systems for real world patent systems as well as patent systems in virtual environments in online computer games. It should be appreciated that numerous embodiments are described in detail and that various combinations and subcombinations of these embodiments are contemplated by the present disclosure.

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps. Furthermore, it will be understood that while various embodiments are described, such embodiments should not be interpreted as being exclusive of the inclusion of other embodiments or parts of other embodiments.

The invention is described with reference to several embodiments. However, the invention is not limited to the embodiments disclosed, and those of ordinary skill in the art will recognize that the invention is readily applicable to many other diverse embodiments and applications as are reflected in the range of real world financial institutions, instruments and activities. Accordingly, the subject matter of the present disclosure includes all novel and nonobvious combinations and subcombinations of the various systems, methods configurations, embodiments, features, functions, and/or properties disclosed herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

A reference to “another embodiment” in describing an embodiment does not necessarily imply that the referenced embodiment is mutually exclusive with another embodiment (e.g., an embodiment described before the referenced embodiment), unless expressly specified otherwise.

The terms “include”, “includes”, “including”, “comprising” and variations thereof mean “including but not limited to”, unless expressly specified otherwise.

The term “consisting of” and variations thereof includes “including and limited to”, unless expressly specified otherwise. The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The terms “such as”, “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” may include one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” includes any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the environment described herein.

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

We claim:

1. A method of outsourcing patent applications for examination comprising:
a) determining a profile for the subject matter of a patent application;
b) determining a profile for an examination agency; and
c) assigning the application to the examination agency with the closest profile to the profile of the subject matter of a patent application to examine the application.

2. The method of claim 1 further comprising creating a profile of examiners at an examination agency.

3. The method of claim 2, wherein determining a profile for an examiner comprises:
a) retrieving examiner history;
b) retrieving the patent applications previously examined by the examiner; and
c) generating a score for an examiner based on the examiner history and the applications previously examined by the examiner.

4. The method of claim 3, wherein a patent examiner history comprises the examiner's education, seniority, number of applications examined, and training.

5. The method of claim 3, wherein the score is generated using artificial intelligence techniques.

6. The method of claim 6, wherein the artificial intelligence techniques are neural net, Bayesian algorithm, genetic algorithms, pattern recognition, expert systems, case based reasoning, fuzzy systems, hybrid intelligent systems, evolutionary computation, or concept processing.

7. The method of claim 1, wherein determining a profile for the subject matter of a patent application comprises:
a) evaluating the field of the invention;
b) evaluating the class of the invention;
c) evaluating the abstract of the invention;
d) evaluating the claims of the invention; and
e) generating a score for the application based on the evaluation.

8. The method of claim 7, wherein the evaluation is made using artificial intelligence techniques.

9. The method of claim 1, wherein determining a profile for an examination agency comprises:
a) retrieving the area of specialization of the agency;
b) retrieving the subject matter of applications previously examined by an agency;
c) retrieving the expertise of the examiners employed by the agency; and
d) generating a score for the examining agency.

10. The method of claim 9, wherein the evaluation is made using artificial intelligence techniques.

11. A method of reviewing patents comprising:
a) receiving a request to review a patent;
b) retrieving the history of the issuance of the patent;
c) generating a profile for the patent;
d) comparing the profile of the patent to the profile of an examiner; and
e) assigning the patent to the examiner with the closest profile.

12. The method of claim 11, wherein the review is requested by the system.

13. The method of claim 11, wherein the review is requested by a third party.

14. The method of claim 11, wherein the examiner may not be the same examiner that initially examined the patent.

15. The method of claim 11, wherein the examiner must be a senior examiner.

16. The method of claim 11, wherein if the examiner determines that the patent is invalid, the patent is reviewed by an additional examiner.

17. A method of reviewing applications comprising:
a) selecting an application for review;
b) generating a patent application score for the selected application;
c) generating a patent attorney score;
d) comparing the patent application score to the patent attorney score; and
e) assigning the application to the patent attorney with the closest score.

18. The method of claim 17, wherein the comparison is made using artificial intelligence techniques.

19. The method of claim 17, wherein the artificial intelligence techniques are neural net, Bayesian algorithm, genetic algorithms, pattern recognition, expert systems, case based reasoning, fuzzy systems, hybrid intelligent systems, evolutionary computation, or concept processing.

20. The method of claim 17, wherein the patent attorney may receive remuneration for the review.
